(19) United States
(12) Patent Application Publication
(10) Pub. No.: US 2016/0252392 A1
(43) Pub. Date: Sep. 1, 2016

(54) PHASE STEP DIFFRACTOMETER

(71) Applicants: MOHAMMAD TAGHI TAVASSOLY, TEHRAN (IR); SEYED ROOHOLLAH HOSSEINI, QOM (IR)

(72) Inventors: MOHAMMAD TAGHI TAVASSOLY, TEHRAN (IR); SEYED ROOHOLLAH HOSSEINI, QOM (IR)

(21) Appl. No.: 14/634,584

(22) Filed: Feb. 27, 2015

(51) Int. Cl. G01J 1/06; G01J 9/02; G01B 11/24; G01J 3/453

(52) U.S. Cl. CPC G01J 1/06; G01J 3/453; G01J 9/02; G01B 11/2441; G01J 2009/0211

(57) ABSTRACT

A phase step diffractometer is disclosed that utilizes Fresnel diffraction from a 1D step. The main part of the device is a step with two flat parallel mirrors on either side. The phase difference (PD) is changed by varying the light incident angle and the step height. The diffracted lights from the step are caught by a CCD connected to a PC. By varying PD, the visibility of the three central diffraction fringes changes. This permits low uncertainties in the measurements of wavelength, coherence length, coherence width, plate thickness, surface topography and fine displacement of objects. In addition, the device can be used in determination of broad spectral line shapes and optical constants of materials.

### FIELD OF INVENTION

The present invention based on applications of Fresnel Diffraction of light from phase step in optical metrology.

### BACKGROUND OF THE INVENTION

It is more than a decade that the Fresnel diffraction from phase steps of one and two dimensions has been studied comprehensively ((Optical diffractometry; Tavassoly et al. 2009) and (Fresnel diffraction from 1D and 2D phase steps in reflection and transmission mode; Amiri et al. 2007)). It is shown that the phase difference (PD) or the corresponding optical path difference (OPD) between the waves diffracted from the two sides of a step edge can be varied by changing the step height and the angle of incidence of light. The latter changes OPD very finely. This has led to many applications including: precise measurements of displacement (Nanometer displacement measurement using Fresnel diffraction; Khorshad et al. 2012), film thickness (Application of Fresnel diffraction from a phase step to the measurement of film thickness; Tavassoly et al. 2009), plate thickness (Applications of Fresnel diffraction from the edge of a transparent plate in transmission; Tavassoly et al. 2012), refractive indices of solids and liquids (High precision refractometry based on Fresnel diffraction from phase plates; Tavassoly et al. 2012) and (Optical refractometry based on Fresnel diffraction from a phase wedge; Tavassoly et al. 2010). Thus, the Fresnel diffraction from phase steps is emerging as a powerful metrological technique with remarkable advantages.

### SUMMARY OF THE INVENTION

The main part of the disclosed invention is a 1D step with variable height that has optically flat mirrors on either sides of the step. The PD between the lights diffracted from the two sides of the step edge is varied by changing the light incident angle and the step height.

The criterion of the measurement is the change in the average visibility of the three central fringes that varies between zero and one for a PD change of π. Thus, on one hand the PD is changed finely by varying the light incident angle and on the other hand the visibility of the fringes is very sensitive to phase change. Thus, combination of these properties makes the device a very accurate measuring tool.

In addition, the repetition of exactly similar diffraction patterns as PD changes and existing a universal curve for the visibility versus PD, improves the accuracy of the measurements considerably. Thus, the device permits to measure wavelength, plate thickness, surface topography coherence length, spatial coherence width more accurate than those are measured by conventional interferometers.

Since, there isn't any optical element between the step and the device detector; measurements are performed in a very wide range of wavelengths.

The device is indispensable for specifying the line shapes of broad spectral lines. Because, one can acquire a large volume of data by choosing suitable step height and varying the PD by changing light incident angle.

Since the active parts of the device are two rather small mirrors that are closely located; the device can be fabricated in a very compact form with very low mechanical noise. This allows using the device in rather rough circumstances.

Replacing the mirrors by two plates with different reflectances and illuminating them with P and S polarized lights, the recorded intensity distributions for different angles of incidence, lead to reliable determination of the optical constants of the plates. Thus, the device can act as an ellipsometer.

Fabricating flat mirrors with fixed steps, but rather small heights, say 10, 50 and 100 micrometers allows to perform Fourier spectroscopy on light source with broad spectral lines like LED and optical filters like interference filters. It is however obvious that the numbers indicated above are simply examples of preferred embodiments and other numbers, say less than 10 and more than 100 micrometers can be used in other embodiments as needed.

### BRIEF DESCRIPTION OF DRAWINGS

FIG. 1, is a sketch of the phase step diffractometer.

FIG. 2a, displays general experimental setup for different measurements.

FIG. 2b, displays the orientation of light beam relative to the device. Light incident angle (θ) is changed by rotating the goniometer around its vertical axis.

FIG. 3, displays diffraction patterns that are observed during alignment of device mirrors (a)-(d). The last pattern belongs to the state of parallel mirrors.

FIG. 4(a)-(d), is the diffraction patterns of light diffracted from the step at different phases. (a) φ≈2 mπ, (b) φ≈(2m+1/2)π, (c) φ≈(2m+1)π, and (d) φ≈(2M+3/2)π, (m is an integer). (e) The universal curve for the average visibility of the three central fringes versus optical path difference divided by wavelength. The lines indicate the visibility change is linear in the 0-0.7 interval.

FIG. 5 shows the visibility curve plotted versus optical path difference for laser light beam.

FIG. 6, displays curve of optical path difference divided by wavelength versus the cosine of angle of incidence which is a line that passes through the origin of coordinate system and provides the interference order m₀.

FIG. 7, displays experimental setup for comparing an unknown wavelength with a known reference wavelength.

FIG. 8, displays the curve of average visibility for three central diffraction fringes versus OPD for a red commercial LED.

FIG. 9, displays the number of maximum average visibility of the three central diffraction fringes versus cosine of incident angle in the diffraction of a red LED light beam from a step of height h≈29.6 μm.

FIG. 10, displays configuration of the step with the step edge parallel to the incident plane of light (XY plane); this orientation is used for investigation of spatial coherence properties of light.

FIG. 11, displays average visibility of the three central diffraction fringes versus the spacing of the interfering beams (D in FIG. 10) in the Fresnel diffraction of light from a step with the step edge parallel to the plane of light incidence.

FIG. 12, is a sketch for determination of plate thickness, it is mounted on an optically flat surface to form a step.

FIG. 13 is a sketch of the device that is designed for performing surface topography.

### LIST OF ALL THE COMPONENTS OF THE PREFERRED EMBODIMENTS:

1 Step device (phase step diffractometer)
2 First mirror
4 Second mirror
6 First stand for the first mirror
8 Second stand for the second mirror
10 Micrometer
12 Step height
14, 16, 18 Screw
30 Goniometer
=Source of known (He—Ne laser) or unknown Wavelength
34 Laser Beam (when used as reference laser in the setup it is a known beam and when used as unknown beam in setup it is an unknown beam)
36 Beam expander
38 reflected beam from step
40, 72, 104 CCD camera
42 Goniometer's arm
44, 74, 106 PC
50 Source of unknown wavelength
52 beam of Unknown wavelength
54 First Beam expander
56 Collimated Unknown wavelength
58 Collimated Unknown wavelength transmitted from beam splitter
60 Source of reference (known) wavelength
62 Reference Beam
64 Second Beam expander
66 Collimated Unknown wavelength
68 Collimated reference wavelength reflected from beam splitter
70, 92 Beam splitter
80 Opaque plate
82 Optically flat surface
84 the step that is formed with contact of Opaque plate and Optically flat surface
90 A parallel beam of light
96 Reflected light from beam splitter
98 Optically flat plate
100 Sample surface
100 Step that formed from an optically flat plate and sample surface
102 Diffracted light that transmits from beam splitter and reaches to CCD camera.

### DETAILED DESCRIPTION OF THE INVENTION

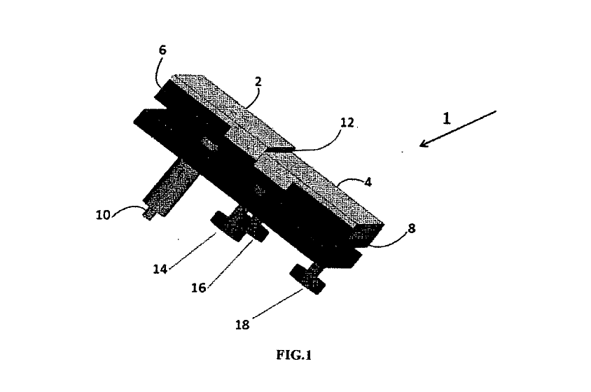

In this invention, we introduce a phase step diffractometer for application in optical metrology. FIG. 1 shows the embodiment of device of a step with variable height (1). The main optical elements of the device are two rectangular flat minors (2, 4) with sharp edges on one side. Of course, depending on the application and convenience in fabrication the dimensions of the flat mirrors (2, 4) are varied between few millimeters up to several centimeters.

Mirrors (2, 4) are mounted on two separate stands (6, 8) with a very narrow gap between the mirrors' sharp edges for the step of zero height. In order to change the step height (12), one of the mirrors; first mirror; (2) is displaced in the direction perpendicular to its surface by a provided micrometer (10). However, the precise step height (12) is determined by the experiment. The planes of mirrors (2, 4) are aligned by manipulating the screws (14, 16 and 18), (that are equipped with restoring springs which are not shown in FIG. 1), that are installed on the second stand (8) of the second mirror (4).

### Experimental Setup

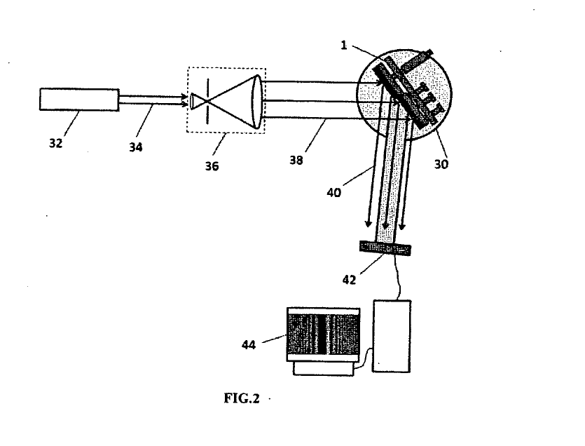

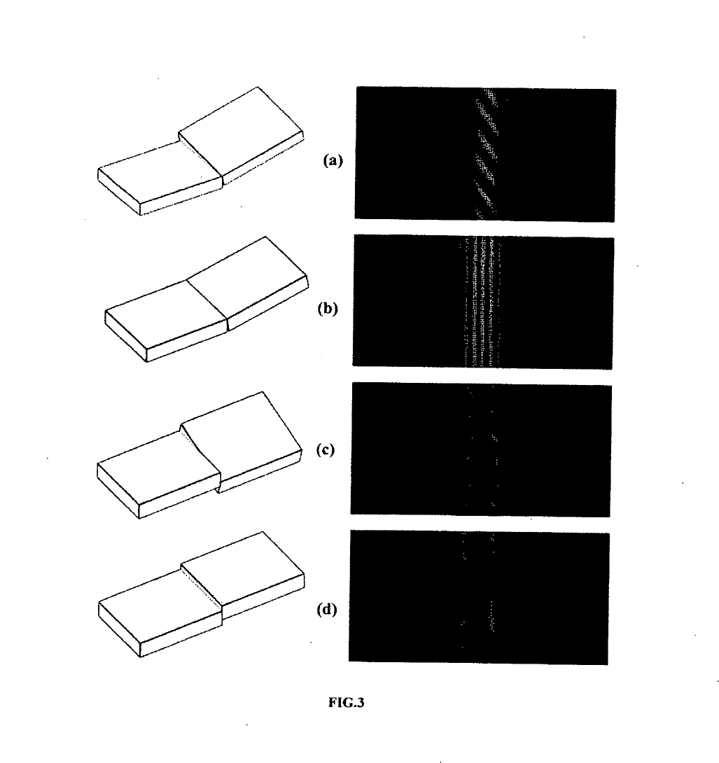

General setup for performing different measurements is shown in FIG. 2a. In this setup, the variable step device (1) is mounted on the stage of a goniometer (30) that is rotatable around a vertical axis with fine precision. For alignment and calibration of the step device (1), the step device (1) is illuminated with a source of known wavelength (32) (He—Ne laser). A beam (34) that is collimated by a beam expander (36) strikes the step device (1) and the diffracted light reflected from a step (38) is caught by a CCD camera (40) mounted on the goniometer's arm (42). The CCD camera (40) is connected to a PC (44). It should be recalled that optical path difference (OPD) or phase difference (PD) is varied by changing the light incident angle on the step (FIG. 2b). The angle of incidence is varied by rotating the goniometer around its vertical axis.

### Alignment of the Device

In general, the mirrors (2, 4) are not parallel and depending on their mutual orientations in the neighborhood of the aligned position, one of the Fresnel diffraction patterns shown in FIG. 3 is observed. The pattern in FIG. 3a corresponds to a situation that two suitable perpendicular rotations of the rotatable mirror around its two perpendicular sides brings the mirrors (2, 4) in parallel position. The pattern in FIG. 3b implies that the mirrors (2, 4) make a small angle with each other with its apex parallel to the gap direction. The pattern in FIG. 3c indicates that the mirrors (2, 4) make a wedge with the apex perpendicular to the gap line direction. The pattern in FIG. 3d belongs to the situation with parallel mirrors (2, 4). For the most of measurements, this orientation is used and by displacing one of the mirrors (2, 4) in the direction normal to its surface different step heights are arranged.

### Theoretical Background

When light beam (34) strikes the step device (1) at angle of incidence θ, the phase difference (PD) φ and optical path difference (OPD) Δ of the diffracted lights from two sides of step edge is:

$$j = \frac{2 p}{I} Δ , Δ = 2 h cos q \qquad ( 1 )$$

Where h and λ stand for the height of step device (1) and light wavelength. (see for example Optical diffractometry; Tavassoly et al. 2009 and Fresnel diffraction from 1D and 2D phase steps in reflection and transmission mode; Amiri et al. 2007).

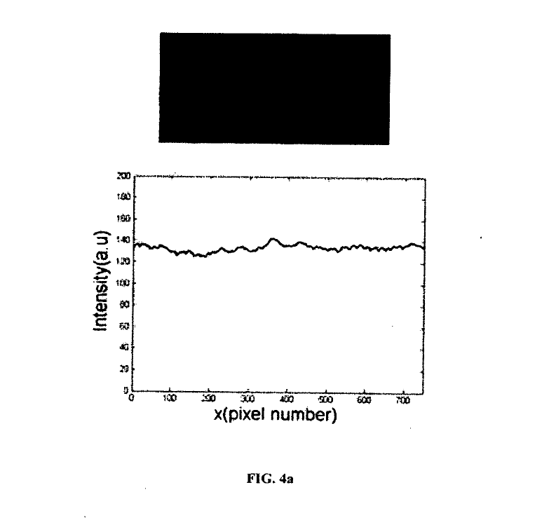

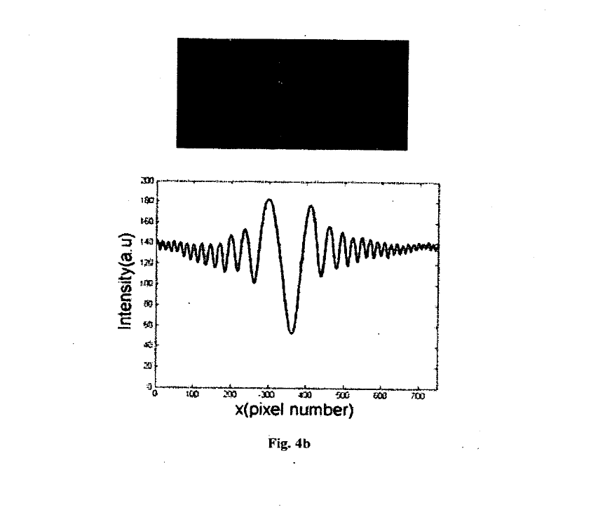

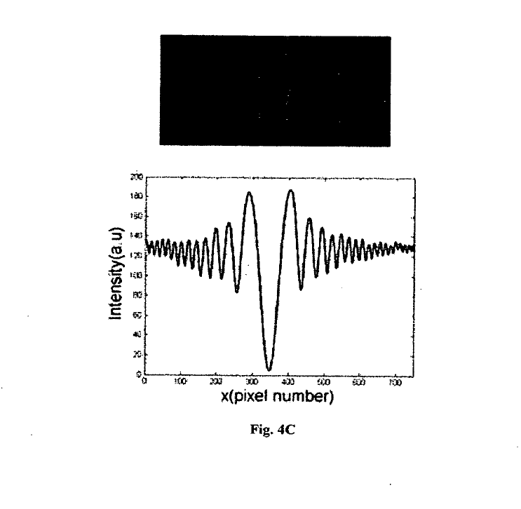

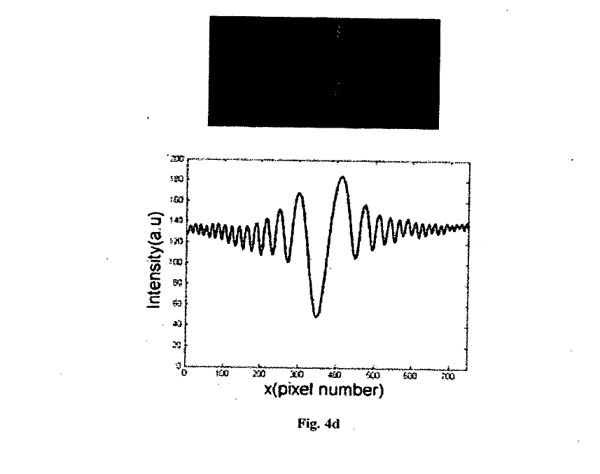

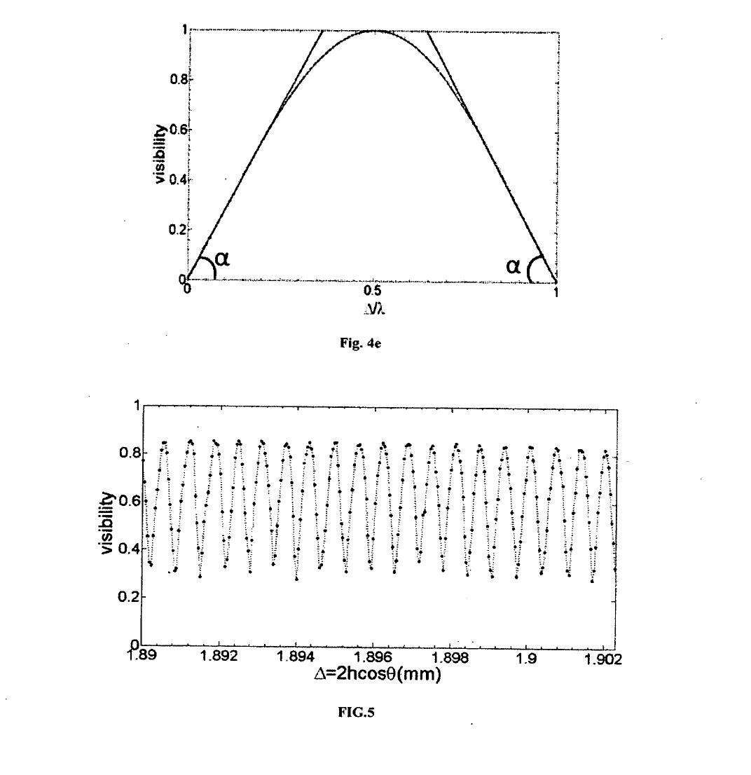

The typical diffraction patterns and the corresponding intensity profiles of lights diffracted from a step with different phases in one period are shown in FIG. 4(a-d). The average visibility for the three central fringes defined by:

$$V = \frac{\frac{{I}_{L} + {I}_{R}}{2} - {I}_{C}}{\frac{{I}_{L} + {I}_{R}}{2} + {I}_{C}} , \qquad ( 2 )$$

Where I_{L}, I_{R} stands for maximum intensities of the bright fringes on the left and the right sides of the central dark fringe with minimum intensity I_{C}.

For the mirrors with the same reflectance, the visibility as function of OPD varies between 0 and 1 and the maximum visibility occurs for PD equals to an odd number of π, FIG. 4c.

FIG. 4e shows the plot of the defined visibility versus OPD divided by λ in one period. In FIG. 5 the average visibility of the three central diffraction fringes is plotted versus OPD divided by λ, for He—Ne laser light, λ=632.8 nm, for a step of 1.06 mm height in the incident angle interval of 26°-27°, according to Eq. 1.

### Measurement of the Step Height

Zero angle of incidence: Precise measurement of the step height (12) is necessary for accurate measurements of different quantities. For the precise measurement of the step height (12), specification of the zero angle of incidence is vital. To find the latter we illuminated the device's minors (2, 4) perpendicularly with a parallel beam of light (34) and record the corresponding reading on the goniometer (30). Then, we turn the step device (1), say to the right very slowly and record the corresponding readings on the goniometer (30) for several visibility maxima as precisely as possible. Then, we repeat the same procedure for the other direction. Finally, we determine the best zero angle of incidence by adjusting the readings on both sides. Then we measure the step height (12) by the following methods.

### 1. Counting the Repetition Visibility

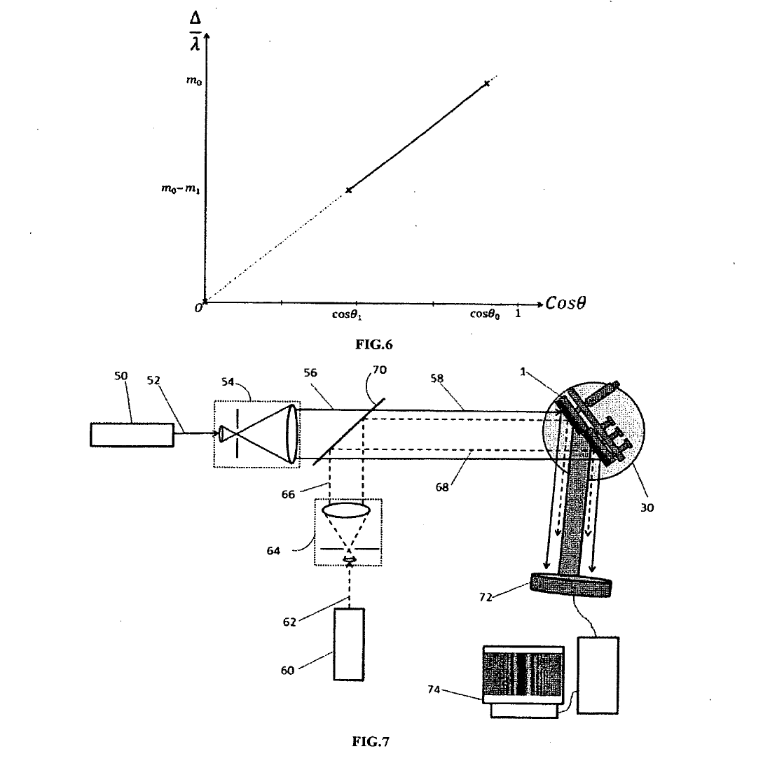

After setting the step device (1) at the state of zero angle of incidence, we turn the goniometer stage to a maximum visibility state at small incident angle θ₀. At this angle, we have:

$$( 2 {m}_{0} + 1 ) \frac{l}{2} = 2 h cos {q}_{0} , \qquad ( 3 )$$

Where m₀ is the order of the interference (FIG. 6). By counting m₁ successive visibility maxima, we arrive at incident angle θ₁ satisfying the following equation:

$$( 2 ( {m}_{0} - {m}_{1} ) + 1 ) \frac{l}{2} = 2 h cos {q}_{1} . \qquad ( 4 )$$

Subtracting Eq. 4 from Eq. 3 leads to:

$${m}_{1} = \frac{2 h}{l} ( cos {q}_{0} - cos {q}_{1} ) , \qquad ( 5 )$$

that provides the step height.

### 2. Specifying the Exact Order of Interferecence Fringe

Dividing Eq. 3 by Eq. 4 and solving the equation for m₀ we get

$${m}_{0} + \frac{1}{2} = \frac{{m}_{1} cos {q}_{0}}{cos {q}_{0} - cos {q}_{1}} \qquad ( 6 )$$

Uncertainty in m₀ is given by:

$$\vert \frac{Δ {m}_{0}}{{m}_{0}} \vert \leq [ \vert tan {q}_{0} \vert + \vert cot ( \frac{{q}_{0} - {q}_{1}}{2} ) \vert ] Δ q . \qquad ( 7 )$$

By choosing θ₀ as small as possible and increasing θ₁, the second term in Eq. 6 tends to 1 and tan θ₀ can be ignored. For the case Δm₀<0.5 the interference order is determined exactly at incident angle θ₀. The rough estimation of m₀ can be obtained by the first method (see S R Hosseini and M T Tavassoly, The application of a phase step diffractometer in wavemetry, J. Opt. 2015).

For example, using a goniometer of 10 arc second precision for a step height about 1.5 mm, and λ=632.8 nm, θ₀=5° for θ₁=57° uncertainty, Δm₀ can be reduced below 0.5 and interference order is determined exactly. The step height is obtained by substituting m₀ and θ₀ in Eq. 3.

### 3. Measurement of Short Step Heights

When the step heights are short, say less than few micrometers, counting the repetition of diffraction patterns does not provide very accurate height. In these cases, we change the light incident angle to get visibility in the 0-0.7 interval. Then by plotting the visibility versus the incident angle cosine in the latter interval, we get a straight line similar to those represented in FIG. 4d. The step height can be derived using the following equation, where V₁ and V₂ are reading on CCD (See Application of Fresnel diffraction from a phase step to the measurement of film thickness, by Tavassoly et al. 2009).

$$h = \frac{l}{5.54} ( \frac{{V}_{2} - {V}_{1}}{cos {q}_{2} - cos {q}_{1}} ) \qquad ( 8 )$$

### Applications of the Device

Before describing the applications of the device, the main features of the phase step is reviewed. a) There is a state of OPD=0 for incident angle of θ=π/2 which provides a natural origin for various measurements. b) In this device the plot of OPD versus the cosine of light incident angle is linear and passes through the origin. c) The OPD varies very finely by changing the light incident angle. d) The measurement criterion is the change in fringe visibility, not fringe shift as in interferometry; this leads to more reliable and precise measurements. e) The effective area of the phase step can be as small as few square millimeters; thus, the device can be very compact with very low mechanical noise. f) Since there is no optical component between the step and the detector, a very wide range of wavelengths can be covered. g) For a given step-screen distance, practically, the shapes and the sizes of diffraction fringes are fixed; independent of the step height and light incident angle, therefore, by choosing suitable step-screen distance the size of diffraction pattern can be adjusted to the size of the monitor. h) The technique can be applied easily and does not require complex and high quality optics. These features are utilized in different measurements.

### Wavemetry

The unknown wavelength of a monochromatic light can be determined by using the general setup of FIG. 2a by the following three methods.

In the first method we illuminate the step device (1) with a given height that is measured by the methods described in preceding section and count the repetitions of diffraction patterns in an incident angle interval θ₀- θ₁ and use Eq. 5 for wavelength determination.

In the second method for a step device (1) with given height we determine the exact order of the interference in the same manner described in preceding section and use Eq. 3 to derive the wavelength. (see S R Hosseini and M T Tavassoly, The application of a phase step diffractometer in wavemetry, J. Opt. 2015).

In the third method, we illuminate the device (1) by the reference and the unknown wavelengths simultaneously FIG. 7. The device (1) is mounted on the stage of a goniometer (30). A beam (34) of unknown wavelength (52) emerging from source (50) is collimated by a first beam expander (54) transmits from beam splitter (70). The beam of the reference wavelength (62) emerging from source (60) is collimated by a second beam expander (64) that is reflected from the beam splitter (70). The two parallel reference (68) and unknown beams (58) strike the step (1) and experience equal OPD. The CCD camera (72), catches the diffraction patterns of both beams and fed them to PC (74). By measuring, the total phase changes for both wavelengths in an incident angle interval and equating the ratio of phases to the inverse ratio of the wavelengths, the unknown wavelength is obtained. In the latter method goniometer of high precision is not required.

### Characterization of Spectral Properties of Braodband Source

A step (1) with known height (12), is illuminated by a broadband light (setup of FIG. 2a). FIG. 8 Shows the plot of visibility for quasi-monochromatic source (such as LED light). The values of maxima and minima of visibility curve changes with the change of OPD and the envelope of maxima and minima of visibility curve depends on the coherence and spectral properties of light. In broadband sources, the temporal coherence length is small and one should work with steps of small heights (of the order of several micrometers).

### Fourier Spectroscopy (Based on Visibility)

The origin of decay in visibility in FIG. 8 is spectral width of the source. The Fourier transform of the upper envelope of the visibility plot provides the spectral line shape, then a function can be fitted on maxima of visibility curve that its Fourier transform gives us the spectrum of light source. Thus, this is a method of Fourier spectroscopy that works suitably for light with broadband spectrum.

### Fourier Spectroscopy (Based on Intensity)

Fourier spectroscopy of broadband sources (including LED and white light sources) can be performed by the introduced phase step, by recording the intensity on the line in diffraction pattern that corresponds to step edge. The intensity at step edge vs OPD is sinusoidal pattern of interference. Then, intensity at the line corresponding to the step edge vs OPD, say interferogram, can be recorded by detector. The Fourier transform of interferogram provides the spectrum of the source as in conventional Fourier spectroscopy based on using interferometer.

The advantage of this method compared with interferometry is that in the former OPD is varied by changing the incident angle very finely. Thus, by choosing suitable step height the Fourier spectroscopy can be performed reliably.

### Average Wavelength of a Broadband Source

One more noteworthy point is that the device is indispensable for the measuring of average wavelengths of broad-band spectral lines and the transmittance of filters. For this kind of measurements, one needs rather small step height permitting smooth change of OPD that is provided by the fine change of incidence angle. At the beginning, one increases the angle of incidence and reduces the OPD below the coherence length of LED light. Then, the visibility maxima are counted for the three central fringes by increasing the angle of incidence smoothly.

The phase difference between two visibility maxima is 2π. The first distinguishable visibility maximum is associated by number m. Then, the successive maxima are labeled by m-1, m-2, m-3, . . . . The plot of visibility maxima number (m) versus the cosine of incident angle (cos θ) is a straight line shown in FIG. 9. Using Eq. 1, the slope of the line provides the average wavelength.

### Determination of the Spatial Coherence Properties of Light Fields

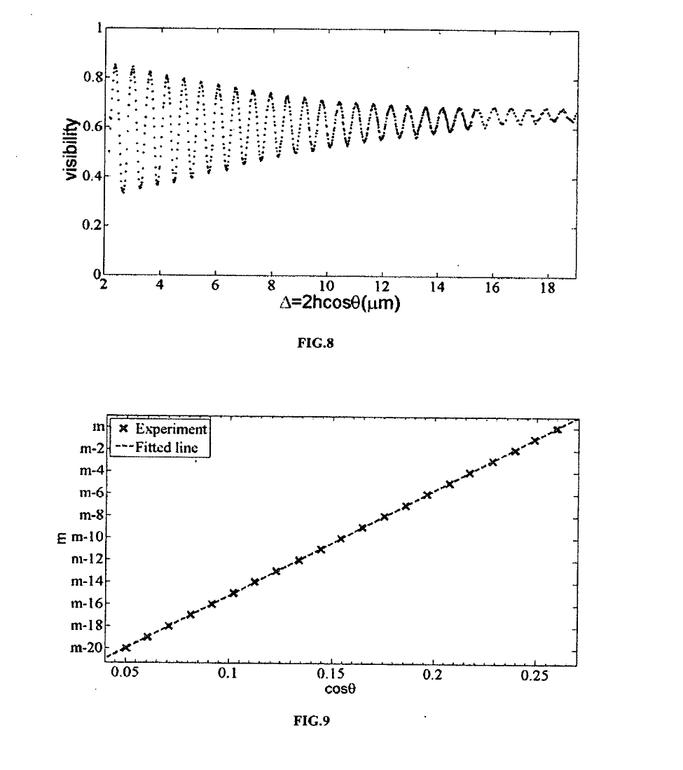

The device (1) in FIG. 1 can be used for the study of spatial coherence properties of light field. For this purpose, the device (1) is mounted on the stage of goniometer (30) of setup in FIG. 2a with the step arrangement shown in FIG. 10. In this arrangement the step edge is parallel to the light incident plane (XY plane) and a slit of small width is put in the focal plane of a beam expander (36) parallel to the step edge of FIG. 2a. In this case, the interfering rays, before striking the step, lie in two planes perpendicular to the incident plane with spacing D given by:

D=2h sin q. (9)

(Investigation of correlation properties of light fields by Fresnel diffraction from a step; by Hosseini et al. 2013)). For perpendicular illumination of the step θ=0, D is zero and the visibility of the fringes is maximum.

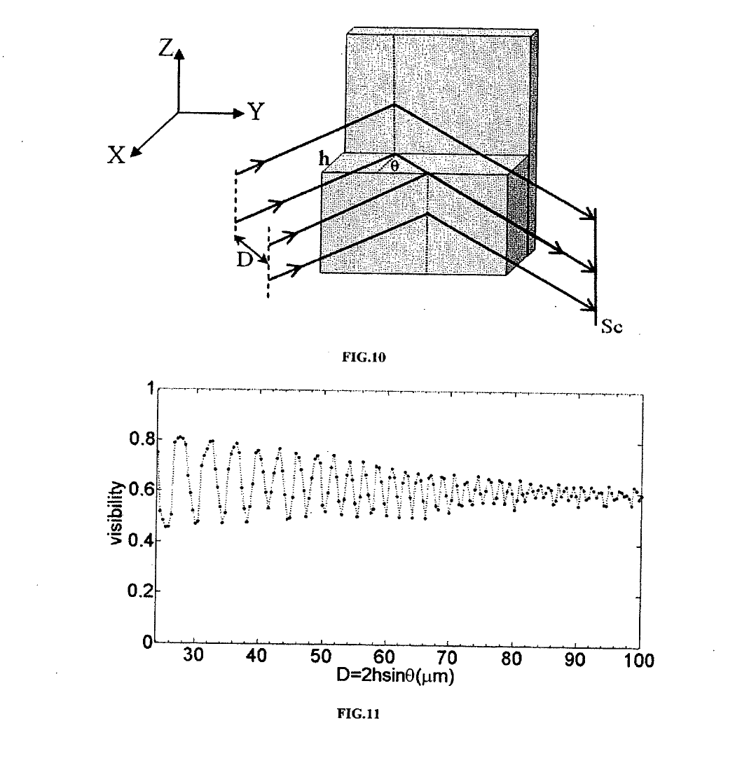

By increasing the incident angle the distance between interfering waves increases according to Eq. 9. FIG. 11 shows visibility versus the spacing of the interfering beams, D, for the green light of Hg source. The envelope of the plot reflects the behavior of the spatial coherence of the beam and the length of the plot is the width of its spatial coherence.

### Determination of Plate Thickness

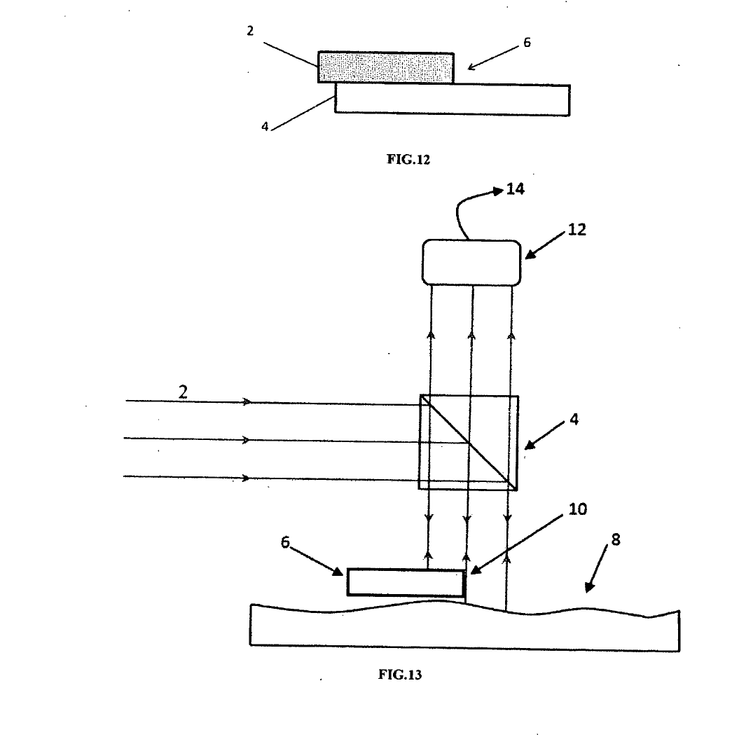

Fresnel diffraction from a step can be applied to the measurements of opaque and transparent pates thickness. Mounting an opaque plate (80) on an optically flat surface (82), the required step (84) is formed FIG. 12. The step (84) is mounted on a goniometer stage (30) and illuminated by a parallel coherent beam of light (34) (setup of FIG. 2a). Then, by varying the incident angle and counting the repetition of diffraction patterns P in an incident angle interval θ₁-θ₂ the plate thickness is determined by the following equation

$$h = \frac{Pl}{2 ( cos {q}_{1} - cos {q}_{2} )} \qquad ( 10 )$$

For the transparent plate, it is just sufficient to install the plate vertically on a goniometer and illuminate the upper edge of plate with a parallel beam of light. In this case a phase step is formed at the boundary of the plate and the surrounding medium because of sharp change of the refractive index. By counting the repetition of transmitted diffraction pattern in an incident angle interval the plate thickness is determined. ((Applications of Fresnel diffraction from the edge of a transparent plate in transmission; by Tavassoly et al. 2012) and (High precision refractometry based on Fresnel diffraction from phase plates; by Tavassoly et al. 2012)).

### Fine Displacement of Objects

The device (1) can be used for fine displacement of the objects. For this purpose, we mount the object on the supporting plate (6) of the first movable mirror (2). By moving the first minor (2), the object is displaced and by counting the repetition of diffraction patterns or recording the changes in the visibility of the fringes, very fine displacement of the object is measured.

### Determination of Optical Constants of Materials

So far we have used mirrors (2, 4) with the same material. We have already shown that the intensity distribution on the diffraction pattern of light diffracted from a step with different materials on each sides of the step edge, depends on optical constants of the materials, step height and light incident angle. ((Optical diffractometry; by Tavassoly et al. 2009) and (Fresnel diffraction from 1D and 2D phase steps in reflection and transmission mode; by Amiri et al. 2007)).

Illuminating such a step with poly chromatic P and S polarized lights and recording the intensity distributions on the diffraction patterns at several incident angles provides a large volume of data for specification of the optical constants of the mirrors' materials. There is no need to a retarder in this method and the technique is applicable in a very large range of wavelengths.

### Surface Topography and Determination of Curvature of Spherical and Aspheric Surfaces

The described step device (1; FIG. 1) with some modification can be applied to accurate surface topography and determination of curvature of spherical and aspheric surfaces. In another embodiment sketch of the device is illustrated in FIG. 13. A parallel beam of light (90) that is reflected (94) from a beam splitter (92) strikes a fixed optically flat plate (96) with rather sharp edge and the sample surface (98) perpendicularly. The diffracted lights (102) from a step (100) made by a plate (96) and a sample (98) surface, after passing through beam splitter (92) is caught by CCD (104) and is fed to a PC (106). The sample surface (98) is displaceable in two dimensions in a plane perpendicular to the incident/reflected beam (94). The height distribution on the sample surface (98) is converted into visibility change. By scanning the sample surface (98) and recording the visibility distribution the topography of the sample surface (98) is performed.

The above identified embodiments describe the invented device in working condition, however it is obvious that other configurations and measurements may be carried out using such device. These embodiments were not intended to limit the functionality and working range of the device, only the description was simply for describing the best mode. It is obvious that the ranges and materials used and the configurations described can be modified for best use in different environments.

1- A phase step diffractometer device comprising:
a) a 1D step with variable height comprising a first and second rectangular flat reflective surfaces on either side; wherein said first and second reflective surfaces are mounted on a first and second stand respectively; wherein said first reflective surface comprises a sharp edge on its distal side and said second reflective surface comprises a sharp edge on its proximal side; wherein said distal side and proximal side of said first and second reflective surfaces respectively face each other with a gap as small as possible forming said 1D step; wherein said first reflective surface and first stand are both attached to a micrometer where said micrometer moves up and down adjusting said height of said step in comparison to where said second reflective surface is located and wherein said second reflective surface and its respective second stand tilt with respect to said first reflective surface via three screws attached to said second stand; wherein an angle between said first and second reflective surfaces changes and respective planes of said first and second reflective surfaces are aligned by manipulating (fastening and/or loosening) said three screws; wherein said step device is mounted on a stage of a goniometer rotating around its vertical axis with fine precision; further comprising a light source of known wavelength; a beam expander; a CCD camera mounted on an arm of said goniometer.

2- A phase step diffractometer device of claim 1, wherein a known light beam generated via said light source collimates via said beam expander and strikes said step device and a resulting diffracted light from said step is projected on said CCD camera; wherein an optical path difference (OPD) Δ and phase difference (PD) φ of said diffracted light from said step is varied by changing a light incident angle and said step height; wherein said light incident angle changes via rotation of said goniometer around its said vertical axis; further comprising means to generate collimated beam from said source; means projecting diffraction pattern of said incident light diffracted from said 1D step on a plane perpendicular to said reflected light from said device; wherein for said angle of incident of θ;
$$j = \frac{2 p}{l} Δ ,$$
Δ=2h cos q; where h and λ, stand for said step height and said known light wavelength.

3- A phase step diffractometer device of claim 2, wherein said first and second reflective surfaces are not parallel and when their said respective planes are aligned in different positions a Fresnel diffraction pattern is seen on said CCD camera.

4- A phase step diffractometer device of claim 3, wherein said step device is aligned when said distal and proximal edges of said first and second reflective mirrors are parallel with respect to one another; said alignment is performed by manipulating said screws therefore diffraction fringes of said 1D step that are parallel fringes appears.

5- The phase step diffractometer device of claim 4; wherein when said second reflective surface is displaced in a direction normal to its surface said step height is changed.

6- The phase step diffractometer of claim 5, further comprising means for automatic processing of images picked up by said CCD camera; wherein said phase difference (φ) of said light diffracted from said distal and proximal edges of said 1D step is processed based on evaluation of intensity distribution and average visibility of said Fresnel diffraction pattern versus said incident angle of said known light beam on said first and second reflective surfaces.

7- The phase step diffractometer of claim 6, when said stage rotates around its vertical axis said light incident angle on said 1D step changes and a visibility of said diffraction pattern varies periodically.

8- The phase step diffractometer of claim 7, wherein said incident angle is setup at zero;
then said incident angle will be changed at small increments θ₀ by rotating said goniometer stage till a maximum visibility state is achieved.

9- The phase step diffractometer of claim 8, wherein an exact order of interference at said incident angle θ₀ denoted by m₀, where
$$( 2 {m}_{0} + 1 ) \frac{l}{2} = 2 h cos {q}_{0} ,$$
is determined as follows: a repetition of said diffraction pattern in interval θ₀-θ₁ is counted with an order change of m₁; Where
$${m}_{0} + \frac{1}{2} = \frac{{m}_{1} cos {q}_{0}}{cos {q}_{0} - cos {q}_{1}} ;$$
by choosing said θ₁ and m₁ so large to make Δm₀<0.5, where
$$\vert \frac{Δ {m}_{0}}{{m}_{0}} \vert \leq [ \vert tan {q}_{0} \vert + \vert cot ( \frac{{q}_{0} - {q}_{1}}{2} ) \vert ] Δ q . ,$$
said m₀ is determined exactly, since said m₀ is an integer number; and wherein by utilizing said m₀ and θ₀ said height of said 1D step is determined very precisely.

10- The phase step diffractometer of claim 8, wherein said step height of an order of a few nanometer is determined by fitting experimental visibilities projected on said CCD camera on an universal visibility curve; wherein said curve is a straight line for visibility range of 0-0.7.

11- The phase step diffractometer of claim 9, wherein after said step height h is calculated; said 1D step device is illuminated by a monochromatic beam of an unknown wavelength λ, where by counting a repetition of said diffraction pattern m₁ in said incident angle intervals of θ₀-θ₁, and determining an exact order of said interference at said incident angle θ₀ denoted by m₀, where
$$( 2 {m}_{0} + 1 ) \frac{l}{2} = 2 h cos {q}_{0} , by {m}_{0} + \frac{1}{2} = \frac{{m}_{1} cos {q}_{0}}{cos {q}_{0} - cos {q}_{1}} ;$$
by choosing θ₁ and m₁ so large to make Δm₀<0.5,where
$$\vert \frac{Δ {m}_{0}}{{m}_{0}} \vert \leq [ \vert tan {q}_{0} \vert + \vert cot ( \frac{{q}_{0} - {q}_{1}}{2} ) \vert ] Δ q . ,$$
m₀ is determined exactly, since m₀ is an integer number; and wherein by utilizing m₀ and θ₀ and h said unknown wavelength is determined very precisely.

12- The phase step diffractometer of claim 9; wherein a beam of unknown wavelength emerges from a first source and is collimated by a first beam expander and transmits from said beam splitter, a beam of reference wavelength emerges from a second source and is collimated by a second beam expander that is reflected by said beam splitter; wherein said two parallel reference and unknown beams strike said 1D step and experience equal OPD; where said CCD camera catches said diffraction patterns of both of said beams which provide fractions of their phase in 2π; and fed them to said PC; where total phase changes of both of said beams is measured; then said incident angle is changed and repetition of fringes for each of said known and unknown wavelength are counted in desired incident angle interval; ratio of said OPDs to an inverse ratio of corresponding said known and unknown wavelengths provides said unknown wavelength.

13- The phase step diffractometer of claim 11, wherein since no optical element is located between said 1D step and a detector to absorb light, wavelengths in a very large range are measurable.

14- The phase step diffractometer of claim 13; wherein for a broadband light source, said visibility changes between 0-1 for said OPD of close to zero; therefore when said OPD increases, said visibility decreases to a fixed value for said OPD more than a light coherence length.

15- The phase step diffractometer of claim 14; wherein average/central wavelengths of said broadband light beam (λ) is measured when said height (h) of said 1D step is in an order of coherence length of said light beam; then a visibility maxima of three central fringes is counted by increasing said angle of incidence smoothly; wherein when a first distinguishable of said visibility maximum is m, said successive visibility maxima would be labeled by m-1, m-2, m-3, . . . ; a plot of said visibility maxima number (m) versus a cosine of said incident angle (cos θ) is a straight line, with slope of 2h/λ; then by plotting said m vs said cos θ and fitting said straight line on them, said central wavelength of said broadband light is determined.

16- The phase step diffractometer of claim 15; wherein when said OPD exceeds said coherence length of said broadband light, said visibility doesn't change with said increase of said OPD.

17- The phase step diffractometer of claim 16, wherein spectral width of said broadband light source can be determined by knowing said central wavelength and said coherence length; wherein by fitting a function on an upper envelope of plot of said visibility vs said OPD and calculating its Fourier transform a spectral line shape is determined, where said spectral line is a base for Fourier spectroscopy of said broadband light source.

18- The phase step diffractometer of claim 17; wherein when said broadband light source is a white light source, for said OPD close to zero for small changes in said OPD, sharp changes appear in color; when said OPD increases, said sharpness of said colors reduces and for said OPD more than said coherence length, two independent sets of edge diffraction fringes appear, and said diffraction pattern doesn't change with changing said OPD.

19- The phase step diffractometer of claim 18; wherein said Fourier spectroscopy of said broadband light source can be realized by said phase step of small height by changing said light incident angle and recording said intensity (I₀) along a strip on a screen of CCD camera that corresponds to said step edge, to form interferogram; then said Fourier transform of said I₀ versus said OPD and said interferogram, provides said spectrum of said light source.

20- The phase step diffractometer of claim 19; wherein very fine changes of said OPD is possible by changing said incident angle.

21- The phase step diffractometer of claim 20; wherein said 1D step determines thickness of opaque and transparent plates; wherein said opaque plate is mounted on either one of said first and second reflective surfaces, said required step is formed; and then by illuminating said 1D step by a parallel coherent light beam and varying said incident angle and counting said repetition of diffraction patterns in said incident angle interval θ₁-θ₂ said plate thickness is determined; wherein said device further determines spatial coherence widths of optical fields.

22- The phase step diffractometer of claim 16; wherein said step edge is parallel to said light incident plane and a slit of small width is placed parallel to said step edge at a focal point of said beam expander; interfering rays, before striking said 1D step, lie in two planes perpendicular to said incident plane with spacing D; wherein D=2h sin q; where said D increases by increasing said incident angle; therefore for said D larger than said coherence width said visibility becomes fixed; wherein said spatial coherence properties of said light source can be determined by determination of plot of visibility vs D.

23- The phase step diffractometer of claim 9; wherein said 1D step determines optical constants of materials; wherein said first and second reflective surfaces are replaced by slides coated by different said materials of unknown optical constants, intensity distribution for P and S polarized light diffracted from said 1D step at several said incident angles is recorded and therefore theoretical said intensity distributions of said optical constants are determined.

24- The phase step diffractometer of claim 23; wherein said 1D step measures fine displacement of objects; wherein said object is fixed on either one of said first and second reflective surfaces; by moving either one of said reflective surfaces and measuring said visibility of said diffraction pattern, said fine displacement of said object is measured.

25- The phase step diffractometer of claim 11; wherein a constant phase step is fabricated with suitable said height and is used for wavemetry.

26- The phase step diffractometer of claim 19; wherein a constant phase step is fabricated with suitable said height which allows measurement of a transmission band of interference filters and line spectra of LEDs and said white light sources; wherein said OPD is changed by changing said light incident angle and recording an intensity (I₀) of a line on said detector corresponding to said step edge; then said Fourier transform of said I₀ versus said OPD and said interferogram, provides said spectrum of said light source.

27- The phase step diffractometer of claim 23; wherein said first and second reflective surfaces comprises different materials but comprise a fixed height wherein optical constants of said materials is measured.

28- The phase step diffractometer of claim 9, wherein said 1D step is used for determining the profile of surfaces and curvatures of spherical and aspheric surfaces.
